(19) United States
(12) Patent Application Publication
(10) Pub. No.: US 2012/0002971 A1
(43) Pub. Date: Jan. 5, 2012

(54) POLARIZATION-TRACKING DEVICE HAVING A WAVEGUIDE-GRATING COUPLER

(75) Inventor: Christopher R. Doerr, Middletown, NJ (US)

(73) Assignee: ALCATEL-LUCENT USA INC., Murray Hill, NJ (US)

(21) Appl. No.: 12/826,799

(22) Filed: Jun. 30, 2010

(51) Int. Cl. H04B 10/00; G02B 6/34; G02B 6/27; G02F 1/035; G02B 6/26

(52) U.S. Cl. 398/115; 385/3; 385/2; 385/27; 385/17; 385/28; 398/159; 398/152

(57) ABSTRACT

A polarization-tracking device having a waveguide grating that serves as a polarization splitter and an optical fiber-to-waveguide coupler. The polarization-tracking device also has an optical mixing circuit configured to receive light from the waveguide grating and a control circuit for tuning the optical mixing circuit. Based on an optical feedback signal received from the optical mixing circuit, the control circuit can configure the latter to produce two optical output signals that represent, e.g., two independently modulated polarization components of a polarization-multiplexed optical input signal or two principal states of polarization of an optical input signal that has been subjected to polarization-mode dispersion. Certain embodiments of the polarization-tracking device lend themselves to convenient implementation in a photonic integrated circuit and are configurable to provide endless polarization control.

### CROSS-REFERENCE TO RELATED APPLICATIONS

The subject matter of this application is related to that of International Patent Application No. PCT/US2009/037746, by C. Doerr, attorney docket reference Doerr 142, filed on Mar. 20, 2009, and entitled “COHERENT OPTICAL DETECTOR HAVING A MULTIFUNCTIONAL WAVEGUIDE GRATING,” which is incorporated herein by reference in its entirety.

### BACKGROUND

1. Field of the Invention

The present invention generally relates to optical communication equipment and, more specifically but not exclusively, to polarization-tracking devices.

2. Description of the Related Art

This section introduces aspects that may help facilitate a better understanding of the invention(s). Accordingly, the statements of this section are to be read in this light and are not to be understood as admissions about what is in the prior art or what is not in the prior art.

A polarization-tracking device is an optical device that transforms an optical input signal with an arbitrary state of polarization (SOP) into one or more optical output signals, each with a specified time-variable or fixed SOP. Polarization-tracking devices find use, e.g., in optical receivers for demodulating polarization-multiplexed (PM) signals, polarization-mode-dispersion (PMD) compensators, and optical systems with polarization-sensitive components. One desired characteristic of a polarization-tracking device is an ability to provide endless polarization control, meaning that the polarization-tracking device is able to maintain the specified output SOP in a continuous manner for an arbitrarily long period of time, without reaching the range limits of the tunable elements used in the device regardless of the variations in the input SOP. Another desired characteristic of a polarization-tracking device is that it should lend itself to a relatively straightforward implementation in an integrated planar-waveguide circuit or a photonic integrated circuit (PIC). Optical-equipment manufacturers are actively developing polarization-tracking devices having these and other desired characteristics.

### SUMMARY

Disclosed herein are various embodiments of a polarization-tracking device having a waveguide grating that serves as a polarization splitter and an optical fiber-to-waveguide coupler. The polarization-tracking device also has an optical mixing circuit configured to receive light from the waveguide grating and a control circuit for tuning the optical mixing circuit. Based on an optical feedback signal received from the optical mixing circuit, the control circuit can configure the latter to produce two optical output signals that represent, e.g., two independently modulated polarization components of a polarization-multiplexed optical input signal or two principal states of polarization of an optical input signal that has been subjected to polarization-mode dispersion. Certain embodiments of the polarization-tracking device lend themselves to convenient implementation in a photonic integrated circuit and are configurable to provide endless polarization control.

According to one embodiment, provided is an apparatus comprising a first waveguide grating and an optical mixing circuit optically coupled to the first waveguide grating through a first plurality of waveguides. The first plurality comprises a first waveguide connected to a first side of the first waveguide grating and a second waveguide connected to a second side of the first waveguide grating. Optical power of a first polarization of an optical input signal applied to the first waveguide grating is coupled by the first waveguide grating into the first waveguide. Optical power of a second polarization of the optical input signal is coupled by the first waveguide grating into the second waveguide. The optical mixing circuit is adapted to mix light received through the first and second waveguides.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of an optical system according to one embodiment of the invention;

FIGS. 2A-B schematically show a polarization-tracking circuit that can be used in the optical system of FIG. 1 according to one embodiment of the invention;

FIG. 3 shows a block diagram of opto-electric circuitry that can be used in the polarization-tracking circuit of FIG. 2 according to one embodiment of the invention;

FIG. 4 shows a schematic top view of a fiber-optic coupling circuit that can be used in the polarization-tracking circuit of FIG. 2 according to one embodiment of the invention;

FIG. 5 shows a schematic top view of a back-end circuit that can be used in the optical system of FIG. 1 according to one embodiment of the invention;

FIG. 6 shows a block diagram of a back-end circuit that can be used in the optical system of FIG. 1 according to another embodiment of the invention; and

FIG. 7 shows a block diagram of an optical receiver according to one embodiment of the invention.

### DETAILED DESCRIPTION

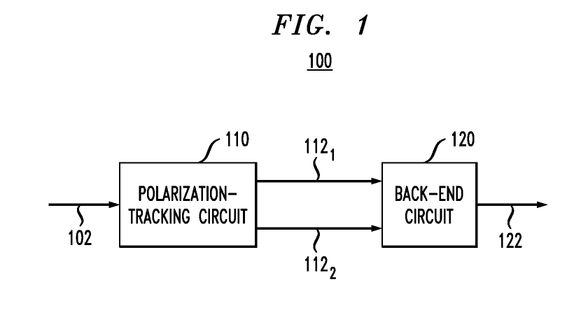

FIG. 1 shows a block diagram of an optical system 100 according to one embodiment of the invention. Optical system 100 has a polarization-tracking circuit 110 coupled to an optical back-end circuit 120. In one implementation, polarization-tracking circuit 110 and optical back-end circuit 120 are parts of a single photonic integrated circuit (PIC). In an alternative implementation, polarization-tracking circuit 110 and optical back-end circuit 120 comprise a combination of one or more integrated waveguide circuits, one or more fiber-optic components, and/or one or more free-space optical elements. As further explained below, in various embodiments, optical system 100 can function as an optical receiver or as a polarization-mode-dispersion (PMD) compensator.

Polarization-tracking circuit 110 receives an optical input signal 102 that is delivered to optical system 100 via an optical fiber. In various embodiments, optical input signal 102 can be (i) an optical signal having a single modulated component or (ii) a polarization-multiplexed (PM) optical signal having two independently modulated polarization components. While being delivered to optical system 100 by the fiber-optic transmission line, optical signal 102 might be subjected to a variety of detrimental effects, such as polarization distortion and polarization-mode dispersion. However, optical system 100 is specifically designed to perform optical-signal processing that enables the system to at least partially offset these detrimental effects.

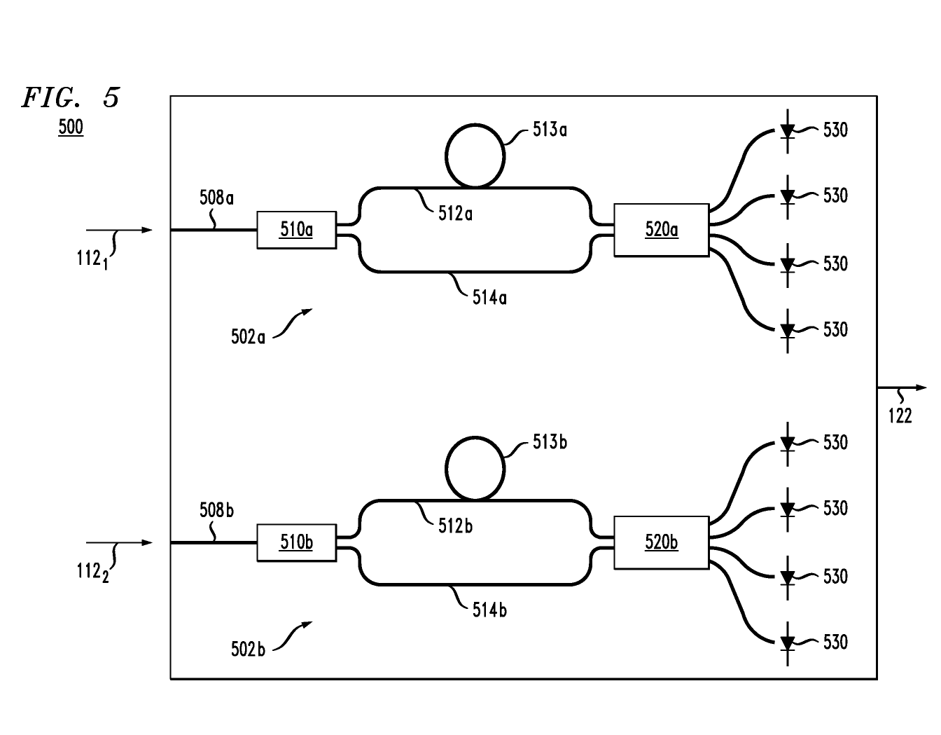

In one embodiment, optical system 100 can be an optical receiver for demodulating and decoding PM signals, wherein back-end circuit 120 is an appropriately designed optical-to-electrical (O/E) converter (also see, e.g., FIG. 5). In such an embodiment, polarization-tracking circuit 110 processes optical input signal 102 to generate optical signals 112₁ and 112₂ so that each of these signals is an optical signal that carries a corresponding one of the two independently modulated polarization components applied to the fiber-optic transmission line by a remote transmitter (not explicitly shown in FIG. 1). In particular, polarization-tracking circuit 110 generates optical signals 112₁ and 112₂ so that each optical signal 112ᵢ has an acceptably low level of crosstalk noise corresponding to the other optical signal 112ⱼ. Polarization-tracking circuit 110 applies optical signals 112₁ and 112₂ to O/E converter 120, where each of these signals can be optically detected in a conventional manner to recover the data carried by PM signal 102. Depending on the type of modulation that is used at the remote transmitter, O/E converter 120 can be designed for (i) direct O/E conversion that employs a plurality of photo-detectors or (ii) a coherent-detection scheme that involves an optical local-oscillator source and/or one or more optical mixers for mixing the input signal with a delayed copy of itself or with a local-oscillator signal. The data recovered by O/E converter 120 are transported out of optical system 100 via an electrical output signal 122.

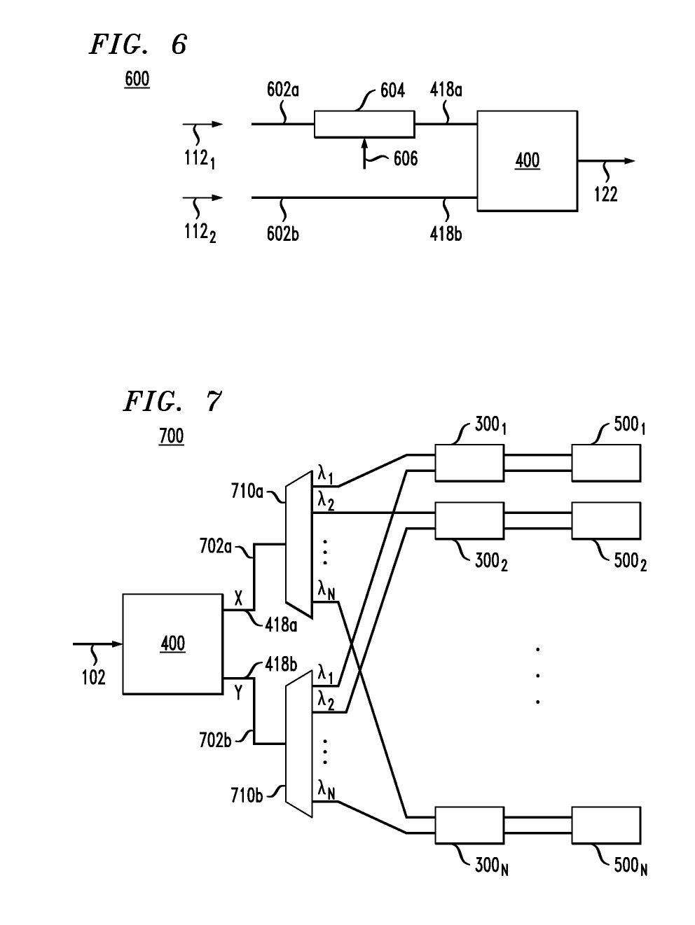

In an alternative embodiment, optical system 100 can be a PMD compensator, wherein back-end circuit 120 includes a differential delay line and a polarization combiner (also see FIG. 6). As known in the art, polarization-mode dispersion is a form of modal dispersion where two different polarizations of light travel in a waveguide (e.g., an optical fiber) at different speeds due to random (static and/or dynamic) imperfections and asymmetries of the waveguide. The speed difference typically causes optical-pulse broadening, which can lead to inter-symbol interference and other detrimental effects.

One known method of reducing the detrimental effects of polarization-mode dispersion involves (i) decomposing the PMD-affected optical signal into two constituent optical signals, each representing a corresponding one of the two principal states of polarization (SOPs) of the fiber-optic transmission line; (ii) introducing an appropriate differential time delay between these two constituent optical signals; and (iii) recombining the resulting delayed optical signals to produce a PMD-compensated optical signal. Accordingly, in the embodiment of optical system 100 functioning as a PMD compensator, polarization-tracking circuit 110 is configured to decompose optical input signal 102 into optical signals 112₁ and 112₂ so that each of these signals represents a corresponding one of the two principal SOPs of the fiber-optic transmission line. Back-end circuit 120 then applies different time delays to optical signals 112₁ and 112₂ and recombines the resulting delayed optical signals to produce an optical output signal 122. Provided that the delays applied by back-end circuit 120 to optical signals 112₁ and 112₂ correspond to the amount of PMD in the fiber-optic transmission line, optical output signal 122 is a PMD-compensated optical signal.

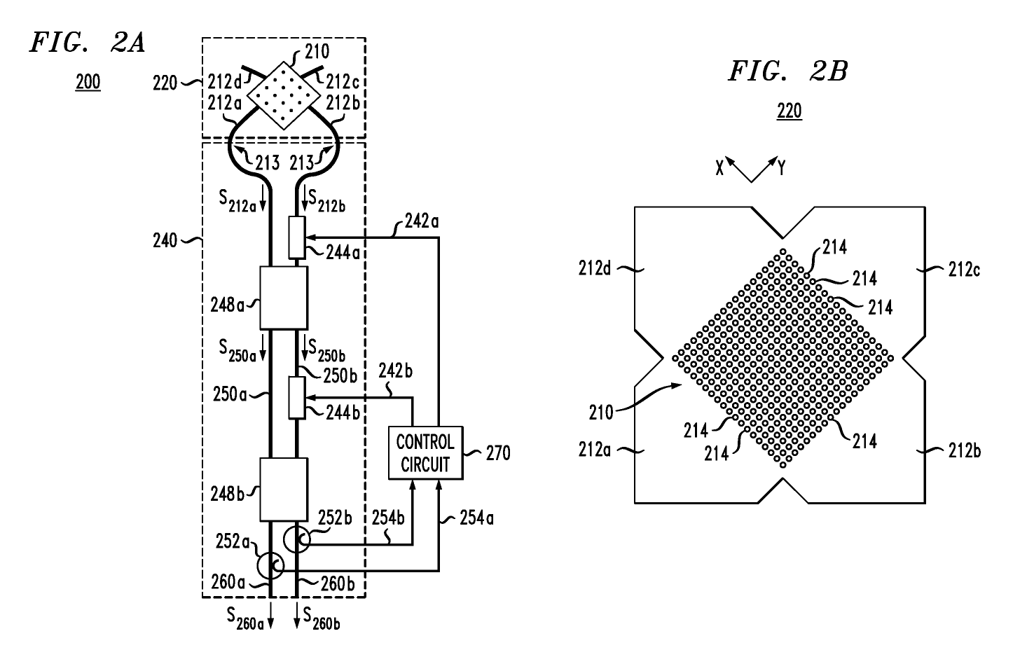

FIGS. 2A-B schematically show a polarization-tracking circuit 200 that can be used as polarization-tracking circuit 110 according to one embodiment of the invention. More specifically, FIG. 2A shows a block diagram of polarization-tracking circuit 200. FIG. 2B shows an enlarged top view of a portion of a fiber-optic coupling circuit 220 used in polarization-tracking circuit 200.

Polarization-tracking circuit 200 includes fiber-optic coupling circuit 220, an optical mixing circuit 240, and a control circuit 270 coupled to each other as indicated in FIG. 2A. In one embodiment, fiber-optic coupling circuit 220 and optical-mixing circuit 240 are all implemented in a monolithic PIC using the integration techniques disclosed, e.g., in U.S. Patent Application Publication No. 2010/0054761, which is incorporated herein by reference in its entirety. Other known integration techniques may likewise be used. In various embodiments, control circuit 270 may or may not be a part of the PIC.

Fiber-optic coupling circuit 220 has a waveguide grating 210. In a representative embodiment, waveguide grating 210 comprises a plurality of features 214, such as cavities, pillars, and/or holes etched into or formed on an upper surface of a ridge waveguide to form a two-dimensional, rectangular or square pattern (see FIG. 2B). Each of the four sides of grating 210 is connected to a corresponding one of ridge waveguides 212a-d. In the area immediately adjacent to waveguide grating 210, waveguides 212a and 212c are collinear with each other and orthogonal to each of waveguides 212b and 212d. Waveguides 212b and 212d are similarly collinear with each other. In certain embodiments, waveguides 212b and 212d are optional and may be omitted. A waveguide grating that can be used as waveguide grating 210 is disclosed, e.g., in U.S. Pat. No. 7,065,272, which is incorporated herein by reference in its entirety.

Waveguide grating 210 serves at least two different functions, e.g., those of (1) a fiber-to-waveguide coupler and (2) a polarization beam splitter. More specifically, if waveguide grating 210 is physically abutted with a single-mode optical fiber, e.g., oriented at a slight angle with respect to the normal to the upper surface of the waveguide grating (e.g., to the surface that is parallel to the page of FIG. 2B), then light from the optical fiber will couple, with relatively low losses, from the optical fiber into waveguides 212a-b, hence the fiber-to-waveguide-coupler functionality of waveguide grating 210. If the light in the optical fiber has two polarization components, e.g., an X-polarization component and a Y-polarization component, then the X-polarization component will couple into waveguide 212a and the Y-polarization component will couple into waveguide 212b, hence the polarization-beam-splitter functionality of waveguide grating 210. Both the X- and Y-polarization components have the same polarization (e.g., transverse-electric, TE) on the chip.

The fiber-optic coupling efficiency of waveguide grating 210 can be optimized for any selected wavelength or a range of wavelengths by using a corresponding appropriate pattern of features 214. For example, the above-cited U.S. Pat. No. 7,065,272 discloses patterns that can be used for efficiently coupling light having wavelengths between about 1500 nm and about 1600 nm. One skilled in the art will appreciate that, to obtain a waveguide grating suitable for efficient coupling of other wavelengths, the disclosed patterns can be modified, e.g., by appropriately changing the periodicity of cavities or holes in the waveguide grating.

The fiber-optic coupling efficiency of waveguide grating 210 can also be optimized for the preferred orientation of the external optical input fiber. For example, if the preferred orientation of the optical input fiber is at a slight angle with respect to the normal to the upper surface of waveguide grating 210, then waveguides 212a and 212b can be laid out to be slightly angled, i.e., not being orthogonal to the corresponding side of the grating, with the angle being related to the preferred tilt angle of the optical input fiber. Alternatively or in addition, the shape of waveguide grating 210 can be changed from the rectangular or square shape indicated in FIGS. 2A-B to a rhomboidal or trapezoidal shape.

In a representative embodiment of polarization-tracking circuit 200, the X polarization from an abutted optical fiber efficiently couples into and propagates along waveguide 212a as a corresponding transverse-electric (TE) waveguide mode. The X polarization couples into waveguide 212b relatively inefficiently, and this coupling is negligible for all practical purposes. Similarly, the Y polarization from the abutted optical fiber couples (i) efficiently into waveguide 212b as a corresponding TE waveguide mode and (ii) negligibly into waveguide 212a. The ability of waveguide grating 210 to couple both X and Y polarizations of the optical input signal into the corresponding TE waveguide modes is beneficial because polarization-tracking circuit 200 can be implemented without the use of half-wave plates normally used for conversion of transverse-magnetic (TM) waveguide modes into the corresponding TE waveguide modes. Such conversion is usually performed in prior-art polarization-tracking circuits to avoid complications arising from very different waveguide-propagation characteristics of the TE and TM waveguide modes.

Optical-mixing circuit 240 has two tunable phase shifters 244a-b, two 2×2 optical couplers 248a-b, and two optical taps 252a-b arranged as indicated in FIG. 2A. Each of tunable phase shifters 244a-b is controlled by a corresponding one of control signals 242a-b applied to the phase shifters by control circuit 270. Control circuit 270 generates control signals 242a-b based on optical feedback signals 254a-b received from optical taps 252a-b, respectively. More specifically, control circuit 270 converts optical feedback signals 254a-b into the corresponding electrical signals, processes these electrical signals using a suitable processing scheme to determine appropriate bias voltages for phase shifters 244a-b, and applies these bias voltages to the phase shifters via control signals 242a-b.

The operating principle of optical-mixing circuit 240 and control circuit 270 can best be understood using the Poincare-sphere representation of polarization, which is well known to persons of ordinary skill in the art. On the Poincare sphere, linear-polarization states map to the equator, circular-polarization states map to the poles, and elliptical-polarization states map to the remainder of the sphere's surface. The great utility of the Poincare-sphere representation comes from the fact that the effect of a birefringent element on the SOP is reduced to a corresponding rotation of the SOP on the Poincare sphere about an axis passing through the eigenpolarizations of the birefringent element.

The Poincare-sphere representation can be used to explain suitable configurations of optical-mixing circuit 240 and control circuit 270 for processing PM optical input signals and PMD-affected optical input signals. However, for brevity, the description that follows refers only to processing PM optical input signals. From this description, one of ordinary skill in the art will be able to understand how to configure optical-mixing circuit 240 and control circuit 270 for processing PMD-affected optical input signals.

In the Poincare-sphere representation, the general effect of the fiber-optic transmission line on the SOP of a PM signal is described by Eq. (1):

$$( \begin{matrix}x \\ y\end{matrix} ) = R ( \begin{matrix}a \\ b\end{matrix} ) \qquad ( 1 )$$

where x and y are the X- and Y-polarization components, respectively, of the optical signal at waveguide grating 210 (see FIG. 2B); R is the rotation matrix that describes the birefringence of the fiber-optic transmission line and is an arbitrary unitary matrix; and a and b are the two independently modulated polarization components of the PM signal applied to the fiber-optic transmission line by the remote optical transmitter. Recall that waveguide grating 210 couples components x and y into waveguides 212a and 212b, respectively, as the corresponding TE waveguide modes, which are denoted in FIG. 2A as signals S₂₁₂ₐ, and S_{212b}, respectively.

Referring to FIG. 2A, phase shifter 244a and optical coupler 248a optically mix signals S₂₁₂ₐ and S_{212b} to produce, in waveguides 250a-b, interference signals S₂₅₀ₐ, and S_{250b}, respectively. Phase shifter 244b and optical coupler 248b then optically mix interference signals S₂₅₀ₐ and S_{250b} to produce, in waveguides 260a-b, interference signals S₂₆₀ₐ and S_{260b}, respectively. This series of optical mixings is described by Eqs. (2) and (3):

$$\begin{matrix}( \begin{matrix}{S}_{250 a} \\ {S}_{250 b}\end{matrix} ) = {M}_{1} ( \begin{matrix}{S}_{212 a} \\ {S}_{212 b}\end{matrix} ) & ( 2 ) \\ ( \begin{matrix}{S}_{260 a} \\ {S}_{260 b}\end{matrix} ) = {M}_{2} ( \begin{matrix}{S}_{250 a} \\ {S}_{250 b}\end{matrix} ) & ( 3 )\end{matrix}$$

where M₁ is the matrix that describes the optical mixing performed by phase shifter 244a and optical coupler 248a, and M₂ is the matrix that describes the optical mixing performed by phase shifter 244b and optical coupler 248b. Combining Eqs. (1)-(3), one arrives at Eq. (4):

$$( \begin{matrix}{S}_{260 a} \\ {S}_{260 b}\end{matrix} ) = {M}_{2} {M}_{1} R ( \begin{matrix}a \\ b\end{matrix} ) \qquad ( 4 )$$

Inspection of Eq. (4) reveals that, if matrix M (≡M₂ M₁R) is a diagonal matrix, then each of signals S₂₆₀ₐ and S_{260b}, faithfully represents the corresponding one of the two independently modulated polarization components of the PM signal applied to waveguide grating 210. In the Poincare-sphere representation, matrices M₁ and M₂ correspond to two consecutive rotations of the SOP about two different rotation axes. In general, one rotation about a fixed rotation axis does not necessarily connect an arbitrary input SOP to a desired output SOP. As a result, at least two rotations about two different fixed rotation axes are needed to connect an arbitrary input SOP to a desired output SOP on the Poincare sphere. Consequently, optical-mixing circuit 240 is designed to have two “SOP-rotation” stages, the first represented by phase shifter 244a and optical coupler 248a and the second represented by phase shifter 244b and optical coupler 248b.

In operation, control circuit 270 uses optical feedback signals 254a-b to determine appropriate bias voltages for phase shifters 244a and 244b that enable diagonalization of matrix M. Control circuit 270 then uses control signals 242a and 242b to apply the determined bias voltages to phase shifters 244a and 244b, respectively. In one configuration, control circuit 270 generates control signals 242a and 242b so that M₂M₁=R⁻¹, where R⁻¹ is the inverse of matrix R.

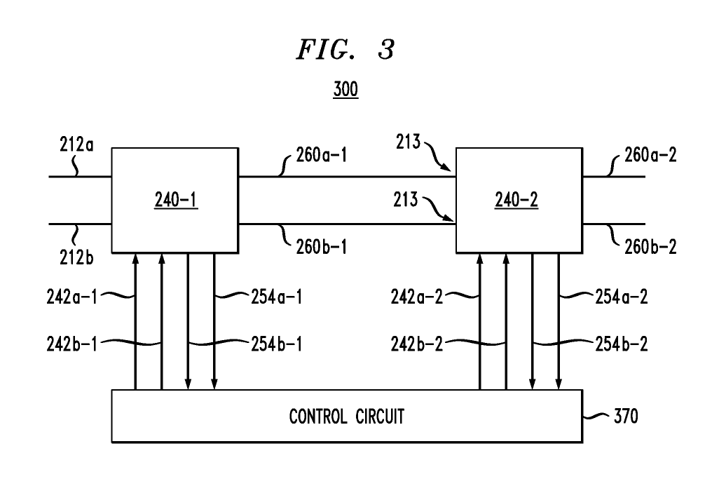

FIG. 3 shows a block diagram of circuitry 300 that can be used in polarization-tracking circuit 200 according to one embodiment of the invention. The intended use of circuitry 300 in polarization-tracking circuit 200 is a replacement of optical-mixing circuit 240 and control circuit 270. The use of circuitry 300 in polarization-tracking circuit 200 is beneficial because it enables the polarization-tracking circuit to provide endless polarization control as further explained below. Circuitry 300 is capable of providing endless polarization control primarily due to the use of two optical-mixing circuits 240, which should be contrasted with the use of just one such circuit as shown in FIG. 2A.

Circuitry 300 comprises two serially connected optical-mixing circuits 240, which are labeled 240-1 and 240-2, respectively. More specifically, two output ports of optical-mixing circuit 240-1 represented by waveguides 260a-1 and 260b-1 are connected to two input ports 213 of optical-mixing circuit 240-2 (also see FIG. 2A, where input ports 213 are marked). Two output ports of optical-mixing circuit 240-2 represented by waveguides 260a-2 and 260b-2 serve as optical output ports of circuitry 300.

Optical-mixing circuits 240-1 and 240-2 are coupled to and controlled by a single control circuit 370. Control circuit 370 differs from a mere combination of two control circuits 270 of FIG. 2 in that control circuit 370 generates four control signals 242 based on processing four optical feedback signals 254 so that any of the four optical feedback signals can affect any of the four control signals. In a typical configuration, control circuit 370 runs an endless-polarization-control algorithm that causes concerted tuning of all four phase tuners 244 (see FIG. 2A) in optical-mixing circuits 240-1 and 240-2 in a manner that prevents any of the phase tuners from reaching their respective tunability range limits regardless of how the input SOP changes over time. Representative endless-polarization-control algorithms that can be used in control circuit 370 are disclosed, e.g., in U.S. Pat. Nos. 7,528,360, 7,443,504, 7,307,722, and 6,947,618, all of which are incorporated herein by reference in their entirety.

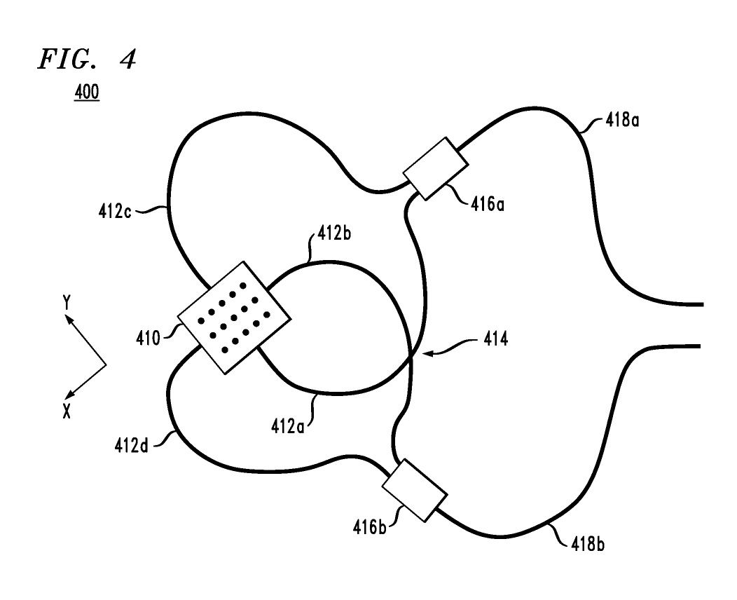

FIG. 4 shows a schematic top view of a fiber-optic coupling circuit 400 that can be used as fiber-optic coupling circuit 220 according to one embodiment of the invention. Fiber-optic coupling circuit 400 is specifically designed for coupling light to or from an optical fiber that is oriented orthogonally to a principal plane of the coupling circuit (e.g., the plane of FIG. 4). Recall that fiber-optic coupling circuit 220 provides optimal coupling efficiency when the optical fiber is slightly tilted with respect to the upper surface of waveguide grating 210 (see FIG. 2), rather than being orthogonal to it.

Fiber-optic coupling circuit 400 has a waveguide grating 410 that is generally analogous to waveguide grating 210 of FIG. 2. Each of the four sides of grating 410 is connected to a corresponding one of ridge waveguides 412a-d. In the area immediately adjacent to waveguide grating 410, waveguides 412a and 412c are collinear with each other and orthogonal to each of waveguides 412b and 412d. Waveguides 412b and 412d are similarly collinear with each other.

Waveguide grating 410 serves at least three different functions, e.g., those of (1) a fiber-to-waveguide coupler, (2) a polarization beam splitter, and (3) two power splitters, one for each of two orthogonal polarizations of the optical input signal (e.g., optical signal 102, FIG. 1). The first two functions have already been described above in reference to waveguide grating 210 and FIG. 2. The third function can be described as follows. If the light in the orthogonally oriented optical fiber abutted with waveguide grating 410 has both X- and Y-polarization components, then the X-polarization component will couple into waveguides 412a and 412c, and the Y-polarization component will couple into waveguides 412b and 412d. The coupled optical power of the X polarization will be divided substantially evenly between waveguides 412a and 412c, hence the power-splitter functionality of waveguide grating 410 for the X polarization. Similarly, the coupled optical power of the Y polarization will be divided substantially evenly between waveguides 412b and 412d, hence the power-splitter functionality of waveguide grating 410 for the Y polarization.

Fiber-optic coupling circuit 400 further has two 2×1 optical couplers 416a-b. Coupler 416a optically couples waveguides 412a and 412c to waveguide 418a. The lengths of waveguides 412a and 412c between waveguide grating 410 and coupler 416a and the geometry of the coupler itself are such that the optical signals applied to the coupler by waveguides 412a and 412c interfere constructively at the proximal end of waveguide 418a. Coupler 416b similarly couples waveguides 412b and 412d to waveguide 418b.

Waveguides 412a and 412b intersect to create a waveguide crossing 414. The angle between waveguides 412a and 412b in waveguide crossing 414 is typically between about 80 and about 100 degrees. In one embodiment, to reduce crosstalk between waveguides 412a and 412b, waveguide crossing 414 incorporates one or more multimode-interference (MMI) couplers as disclosed, e.g., in U.S. Pat. No. 7,058,259, which is incorporated herein by reference in its entirety.

Although fiber-optic coupling circuit 400 is described above in reference to coupling light from an external optical fiber (which is positioned next to waveguide grating 410) to the on-chip waveguides (e.g., waveguides 412), one skilled in the art will appreciate that the operation of this fiber-optic coupling circuit is reversible. This means that fiber-optic coupling circuit 400 can also be used for coupling light from the on-chip waveguides to an external optical fiber. Similar reversibility also applies to the operation of fiber-optic coupling circuit 220 shown in FIG. 2.

FIG. 5 shows a schematic top view of an optical detector 500 that can be used as back-end circuit 120 according to one embodiment of the invention. Detector 500 can be used, e.g., for optical differential quadrature-phase-shift-keying (DQPSK) demodulation of PM signals. As known in the art, DQPSK modulation uses transitions between four points on a constellation diagram, the points being equispaced on a circle centered on the origin. With four different phase increments (e.g., 0, 90, 180, and −90 degrees) corresponding to various possible transitions, DQPSK encodes two bits per transition.

Detector 500 has two detector portions 502a and 502b that are analogous to each other. In one representative configuration, input ports 508a and 508b of detector portions 502a and 502b can be coupled to waveguides 260a and 260b, respectively, of polarization-tracking circuit 200 (see FIG. 2A). In another representative configuration, input ports 508a and 508b can be coupled to waveguides 260a-2 and 260b-2, respectively, of circuitry 300 (see FIG. 3). In both of these configurations, each detector portion 502 performs demodulation of the corresponding one of the two independently modulated polarization components of the PM input signal (e.g., signal 102, FIG. 1). The input signals applied to input ports 508a and 508b correspond to input signals 112₁ and 112₂, respectively, and the electrical output signal generated by detector 500 corresponds to output signal 122 (see FIG. 1).

Detector portion 502 achieves DQPSK demodulation by determining the carrier-phase increment between two consecutive optical symbols. A power splitter 510 splits the optical signal applied to input port 508 into two beams and couples those beams into waveguides 512 and 514, respectively. Waveguides 512 and 514 direct the beams to the respective input ports of a 2×4 optical coupler 520. When the two beams arrive at optical coupler 520, they do so with a relative time delay corresponding to the length difference between waveguides 512 and 514, which length difference is schematically indicated in FIG. 5 by a waveguide loop 513. Signal-propagation time through waveguide loop 513 approximately equals one optical-symbol period.

Optical coupler 520 is designed to act as an optical 90-degree hybrid, as disclosed, e.g., in U.S. Pat. No. 7,343,104, which is incorporated herein by reference in its entirety. More specifically, the optical signals applied to the two input ports of optical coupler 520 interfere in the coupler so that the output port at which the interference signal appears depends on the phase difference between the input signals. As a result, the signals generated by four photo-detectors 530 coupled to the four output ports of optical coupler 520 can be used to unambiguously determine the phase increment between two consecutive optical symbols and, hence, the corresponding two bits encoded thereby.

FIG. 6 shows a block diagram of a back-end circuit 600 that can be used as back-end circuit 120 according to another embodiment of the invention. Back-end circuit 600 is designed for (i) time-aligning optical signals corresponding to the principal SOPs of a PMD-affected signal, (ii) recombining the time aligned optical signals to generate a corresponding PMD-compensated signal, and (iii) coupling the PMD-compensated signal into an external optical fiber. In one representative configuration, input ports 602a and 602b of circuit 600 can be coupled to waveguides 260a and 260b, respectively, of polarization-tracking circuit 200 (see FIG. 2A). In another representative configuration, input ports 602a and 602b can be coupled to waveguides 260a-2 and 260b-2, respectively, of circuitry 300 (see FIG. 3). The input signals applied to input ports 602a and 602b correspond to input signals 112₁ and 112₂, respectively, and the optical output signal produced by fiber-optic coupling circuit 400 of back-end circuit 600 corresponds to output signal 122 (see FIG. 1).

In operation, back-end circuit 600 receives, through input ports 602a and 602b, two optical signals corresponding to the principal SOPs of the PMD-affected signal received by the preceding polarization-tracking circuit 110 (FIG. 1). Circuit 600 then uses a tunable delay line 604 to delay the optical signal corresponding to the “fast” principal SOP with respect to the optical signal corresponding to the “slow” principal SOP. The delayed signals are applied to fiber-optic coupling circuit 400, which, in this case, is configured to operate in the “reverse” direction, i.e., for coupling light from on-chip waveguides 418a and 418b to an external optical fiber positioned next to waveguide grating 410 (also see FIG. 4). Provided that the delay time imparted by delay line 604 corresponds to the amount of PMD in the PMD-affected signal, the optical signal that is coupled by fiber-optic coupling circuit 400 into the external optical fiber can be substantially free of PMD-induced optical-pulse broadening. In one embodiment, the delay time of tunable delay line 604 can be changed using a control signal 606 generated by an external control circuit, such as control circuit 270 (FIG. 2) or control circuit 370 (FIG. 3).

FIG. 7 shows a block diagram of an optical receiver 700 for receiving and demodulating optical wavelength-division-multiplexed (WDM) signals according to one embodiment of the invention. More specifically, optical receiver 700 is designed for receiving an optical WDM signal, in which at least some of the constituent wavelengths carry the corresponding PM signals. For illustration purposes, it is assumed that the optical WDM signal has N wavelengths (λ₁, λ₂, . . . λ_{N}), where N is an integer greater than 2. One skilled in the art will understand that optical receiver 700 can similarly be designed for N=2. As seen in FIG. 7, optical receiver 700 incorporates many of the circuits that have already been described above. The description of these circuits is not repeated here.

Optical receiver 700 has fiber-optic coupling circuit 400 of FIG. 4 configured to couple light 102 from an external optical fiber that is positioned next to waveguide grating 410 (also see FIGS. 1 and 4) into waveguides 702a and 702b, as described above in reference to FIG. 4. Due to this coupling, optical signals corresponding to the X and Y polarizations of the received WDM signal are directed, by waveguides 702a and 702b, to wavelength de-multiplexers 710a and 710b, respectively. Each de-multiplexer 710 de-multiplexes the received optical signal into its constituent WDM components (wavelengths) and directs these WDM components to a plurality of circuits 300. More specifically, circuit 300₁ receives (i) the optical signal corresponding to the X polarization of wavelength λ₁ from de-multiplexer 710a and (ii) the optical signal corresponding to the Y polarization of wavelength λ₁ from de-multiplexer 710b. Circuit 300₂ receives (i) the optical signal corresponding to the X polarization of wavelength λ₂ from de-multiplexer 710a and (ii) the optical signal corresponding to the Y polarization of wavelength λ₂ from de-multiplexer 710b. Circuit 300_{N} receives (i) the optical signal corresponding to the X polarization of wavelength λ_{N} from de-multiplexer 710a and (ii) the optical signal corresponding to the Y polarization of wavelength λ_{N} from de-multiplexer 710b.

Circuit 300₁ processes the received optical signals in a manner described above in reference to FIG. 3 to produce two optical output signals, each carrying a corresponding one of the two independently modulated polarization components of wavelength λ₁. These output signals are directed to optical detector 500₁, where each of them is demodulated in a manner described above in reference to FIG. 5. As a result, circuit 300₁ and optical detector 500₁ recover the data modulated onto both polarizations of wavelength λ₁.

Other circuit 300/detector 500 pairs similarly recover the data modulated onto other wavelengths of the optical WDM signal. For example, circuit 300₂ and optical detector 500₂ recover the data modulated onto both polarizations of wavelength λ₂. Likewise, circuit 300_{N} and optical detector 500_{N} recover the data modulated onto both polarizations of wavelength λ_{N}. Therefore, optical receiver 700 performs full demodulation of an optical WDM signal having N wavelengths, wherein each wavelength carries a PM signal.

The present invention may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope. For example, various optical devices can be implemented as corresponding monolithic PICs, including implementations as substantially planar cards or circuits. Circuits of the invention can be adapted for other modulation formats, such as optical differential phase-shift-keying (DPSK) and optical quadrature-amplitude modulation (QAM). Various optical couplers, such as couplers 248, 416, and 520, may be fixed or tunable. Tunable optical couplers can be controlled by the same control circuit as the corresponding tunable phase shifters, such as control circuit 270 (FIG. 2) or control circuit 370 (FIG. 3). In certain embodiments, fiber-optic coupling circuits 220 and 400 can be used interchangeably. Optical-mixing circuit 240 can be modified to have additional phase shifters inserted into waveguides 212a and 250a. Also, because the apparatus is reciprocal with respect to the signal flow direction, it can be operated in the opposite direction, e.g., to control the output polarization of an optical signal. As used in this specification and the claims, the term “substantially orthogonal” should be interpreted as meaning being oriented at an angle that falls within the range of about 90±15 degrees.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this invention may be made by those skilled in the art without departing from the scope of the invention as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Throughout the detailed description, the drawings, which are not to scale, are illustrative only and are used in order to explain, rather than limit the invention. The use of terms such as height, length, width, top, bottom, is strictly to facilitate the description of the invention and is not intended to limit the invention to a specific orientation. For example, height does not imply only a vertical rise limitation, but is used to identify one of the three dimensions of a three-dimensional structure as shown in the figures. Such “height” would be vertical where the electrodes are horizontal but would be horizontal where the electrodes are vertical, and so on. Similarly, while all figures show the different layers as horizontal layers such orientation is for descriptive purpose only and not to be construed as a limitation.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

What is claimed is:

1. An apparatus, comprising:
a first waveguide grating; and
an optical mixing circuit optically coupled to the first waveguide grating through a first plurality of waveguides, wherein:
the first plurality comprises a first waveguide connected to a first side of the first waveguide grating and a second waveguide connected to a second side of the first waveguide grating;
the apparatus is configured for:
coupling, by the first waveguide grating, optical power of a first polarization of an optical input signal applied to the first waveguide grating to the first waveguide; and
coupling, by the first waveguide grating, optical power of a second polarization of the optical input signal, to the second waveguide; and
the optical mixing circuit is adapted to mix light received through the first and second waveguides.

2. The apparatus of claim 1, wherein the first side is substantially orthogonal to the second side.

3. The apparatus of claim 1, wherein:
the first plurality further comprises a third waveguide connected to a third side of the first waveguide grating and a fourth waveguide connected to a fourth side of the first waveguide grating;
the third side is parallel to the first side; and
the fourth side is parallel to the second side.

4. The apparatus of claim 3, wherein:
the first waveguide grating is configured for splitting the optical power of the first polarization between the first waveguide and the third waveguide; and
the first waveguide grating is configured for splitting the optical power of the second polarization between the second waveguide and the fourth waveguide.

5. The apparatus of claim 3, further comprising:
a first optical coupler that connects the first and third waveguides to a fifth waveguide connected to the optical mixing circuit; and
a second optical coupler that connects the second and fourth waveguides to a sixth waveguide connected to the optical mixing circuit; and
wherein the optical mixing circuit is adapted to mix light received through the fifth and sixth waveguides.

6. The apparatus of claim 3, wherein the first and second waveguides intersect to create a waveguide crossing.

7. The apparatus of claim 1, wherein:
the first waveguide grating comprises a ridge waveguide having on a surface a plurality of features that form a periodic two-dimensional pattern; and
said surface is an input port for receiving the optical input signal.

8. The apparatus of claim 1, configured for:
coupling the optical power of the first polarization into the first waveguide as a transverse-electric (TE) mode of the first waveguide; and
coupling the optical power of the second polarization into the second waveguide as a TE mode of the second waveguide.

9. The apparatus of claim 1, further comprising:
a control circuit for tuning the optical mixing circuit; and
an optical feedback path that connects one or more output ports of the optical mixing circuit to the control circuit, wherein the control circuit is adapted to tune the optical mixing circuit based on optical feedback signals received through the optical feedback path.

10. The apparatus of claim 9, wherein the control circuit is configured to tune the optical mixing circuit based on an endless polarization-control algorithm.

11. The apparatus of claim 1, wherein the optical mixing circuit comprises:
a first phase shifter optically coupled to the first waveguide;
a first optical coupler having a first input port, a second input port, a first output port, and a second output port, wherein:
the first input port is optically coupled to the first phase shifter; and
the second input port is optically coupled to the second waveguide;
a second phase shifter optically coupled to the first output port of the first optical coupler; and
a second optical coupler having a first input port, a second input port, a first output port, and a second output port, wherein:
the first input port is optically coupled to the second phase shifter; and
the second input port is optically coupled to the second output port of the first optical coupler.

12. The apparatus of claim 11, wherein the optical mixing circuit further comprises:
a third phase shifter optically coupled to the first output port of the second optical coupler;
a third optical coupler having a first input port, a second input port, a first output port, and a second output port, wherein:
the first input port is optically coupled to the third phase shifter; and
the second input port is optically coupled to the second output port of the second optical coupler;
a fourth phase shifter optically coupled to the first output port of the third optical coupler; and
a fourth optical coupler having a first input port, a second input port, a first output port, and a second output port, wherein:
the first input port is optically coupled to the fourth phase shifter; and
the second input port is optically coupled to the second output port of the third optical coupler.

13. The apparatus of claim 12, wherein the first phase shifter, the second phase shifter, the third phase shifter, and the fourth phase shifter are tunable to change light-mixing characteristics of the optical mixing circuit.

14. The apparatus of claim 1, further comprising an optical-to-electrical (O/E) converter optically coupled to receive the mixed light produced by the optical mixing circuit, wherein the apparatus is an optical receiver.

15. The apparatus of claim 1, further comprising:
an optical delay line connected to a first output port of the optical mixing circuit; and
a fiber-optic coupling circuit, wherein:
a first input port of the fiber-optic coupling circuit is optically coupled to the optical delay line;
a second input port of the fiber-optic coupling circuit is optically coupled to a second output port of the optical mixing circuit; and
the fiber-optic coupling circuit is adapted to direct light received through the first and second input ports to an external optical fiber.

16. The apparatus of claim 15, wherein:
the fiber-optic coupling circuit comprises a second waveguide grating optically coupled to the first and second input ports through a second plurality of waveguides;
the second waveguide grating comprises a ridge waveguide having on a surface a plurality of features that form a periodic two-dimensional pattern, said surface being adapted to transmit light to the external optical fiber.

17. The apparatus of claim 16, wherein:
the second plurality comprises a first waveguide connected to a first side of the second waveguide grating and a second waveguide connected to a second side of the second waveguide grating; and
the apparatus being configured for:
coupling, by the second waveguide grating, optical power from the first waveguide of the second plurality into a first polarization of an optical output signal directed to the external optical fiber; and
coupling, by the second waveguide grating, optical power from the second waveguide of the second plurality into a second polarization of the optical output signal, the second polarization being orthogonal to the first polarization.

18. The apparatus of claim 1, further comprising:
a first wavelength de-multiplexer optically coupled to the first waveguide grating via the first waveguide and also optically coupled to the optical mixing circuit; and
a second wavelength de-multiplexer optically coupled to the first waveguide grating via the second waveguide and also optically coupled to the optical mixing circuit.

19. The apparatus of claim 18, further comprising one or more additional optical mixing circuits, each optically coupled to the first waveguide grating via the first wavelength de-multiplexer and the second wavelength de-multiplexer, wherein:
each of the first and second wavelength de-multiplexers decomposes light received from the first waveguide grating into a plurality of wavelengths; and
each of the optical mixing circuits is coupled to the first and second wavelength de-multiplexers to receive light of one corresponding wavelength of said plurality of wavelengths.

20. The apparatus of claim 19, further comprising a plurality of optical-to-electrical (O/E) converters, each optically coupled to receive light from a corresponding one of the optical mixing circuits, wherein the apparatus is an optical WDM receiver.
